(19) United States
(12) Patent Application Publication
(10) Pub. No.: US 2005/0112513 A1
(43) Pub. Date: May 26, 2005

(54) Colour photographic copying material

(75) Inventors: Gunter Helling, Odenthal (DE); Ralf Weimann, Leverkusen (DE)

Correspondence Address: CONNOLLY BOVE LODGE & HUTZ, LLP, P O BOX 2207, WILMINGTON, DE, 19899, US

(73) Assignee: AGFA-GEVAERT, Mortsel (DE)

(21) Appl. No.: 10/950,134

(22) Filed: Sep. 24, 2004

(30) Foreign Application Priority Data
Nov. 21, 2003 (DE) DE 103 54 547.6

(51) Int. Cl. G03C 7/26

(52) U.S. Cl. 430/502; 430/553

(57) ABSTRACT

A colour-photographic copying material comprising at least one red-sensitive silver halide emulsion layer containing at least two cyan couplers, at least one green-sensitive silver halide emulsion layer containing at least one magenta coupler, and at least one blue-sensitive silver halide emulsion layer containing at least one yellow coupler, characterised in that at least one cyan coupler corresponds to formula (I) and at least one cyan coupler corresponds to formula (II) 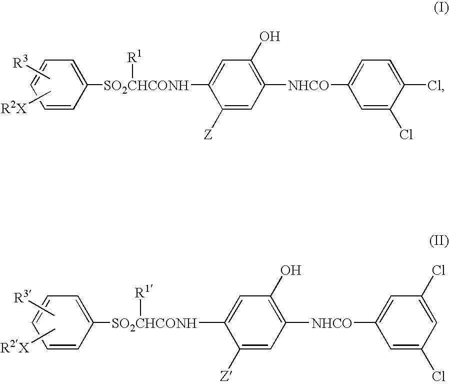 wherein
R¹, R^{1′} represent, independently of one another, a hydrogen atom or an alkyl group,
R², R^{2′} represent, independently of one another, an alkyl or an aryl group,
R³, R^{3′} represent, independently of one another an alkyl, alkenyl, alkoxy, aryloxy, acyloxy, acylamino, sulphonyloxy, sulphamoylamino, sulphonamido, ureido, hydroxycarbonyl, hydroxycarbonylamino, carbamoyl, alkylthio, arylthio, alkylamino or arylamino group or a hydrogen atom, Z, Z′ represent, independently of one another, a hydrogen atom or a group that may be cleaved under the conditions of chromogenic development,
X, X′ represent, independently of one another, S, NH or NR⁴, and
R⁴ represents an alkyl or an aryl group, and wherein at least 20% by weight of each of the cyan couplers of formulae (I) and (II), based on the total quantity of cyan coupler, are contained in the red-sensitive layer, is characterised by good colour reproduction, good dye stability, a smooth surface, a high cyan colour density, and in that it may be produced economically.

The invention relates to a colour-photographic copying material comprising at least two different cyan couplers.

Colour-photographic copying materials are, in particular, materials for images to be viewed by reflection, cine film or displays, which generally display a positive image. They are therefore not a recording medium, as are colour-photographic films.

Colour-photographic copying materials commonly contain at least one red-sensitive silver halide emulsion layer, which contains at least one cyan coupler, at least one green-sensitive silver halide emulsion layer, which contains at least one magenta coupler, and at least one blue-sensitive silver halide emulsion layer, which contains at least one yellow coupler.

Cyan couplers which, after being developed with the CD3 standard paper developer emit cyan dyes, which are characterised by stability to good light and darkness, are known from U.S. Pat. No. 5,686,235. EP 1 113 327 and 1 113 329 disclose structurally related couplers. The couplers have a 2-acylamino-5-phenylsulphonylmethylcarbonylamino-phenol structure, and can be substituted at the methyl group by alkyl and at the phenyl radical by different groups.

However, these couplers have the drawback that the dyes are inadequate in terms of colour reproduction. Substantially improved couplers, in this regard, are known from DE 101 01 221.

The compounds disclosed in said document allow very good colour reproduction and display very good dye stability.

However, some of the representative examples of the cyan couplers disclosed in DE 101 01 221, which are particularly advantageous in terms of colour reproduction, have the drawback that their use causes the surface of the copying material to become rough, as a result of which the tactile properties convey an inferior impression. The silver output is also unsatisfactory. The term “silver output” refers to the colour density that may be obtained with a given quantity of couplers and a given amount of silver halide in a respective layer. With a low silver output, more couplers are required in order to obtain a desired colour density, so the material becomes correspondingly more expensive.

The object of the invention is therefore to avoid the aforementioned drawbacks and, in particular, to obtain a copying material which provides good colour reproduction and good dye stability, with a smooth surface, which provides high cyan colour density and may be produced economically.

It has surprisingly been found that this may be achieved in that at least two cyan couplers having a 2-benzoylamino-5-phenylsulphonylmethyl-carbonylamino-phenyl structure, which differ with regard to the substitution of the benzoyl radical, are used in the copying material.

The invention accordingly relates to a colour-photographic copying material comprising at least one red-sensitive silver halide emulsion layer containing at least two cyan couplers, at least one green-sensitive silver halide emulsion layer containing at least one magenta coupler, and at least one blue-sensitive silver halide emulsion layer containing at least one yellow coupler, characterised in that at least one cyan coupler corresponds to formula (I) and at least one cyan coupler corresponds to formula (II) 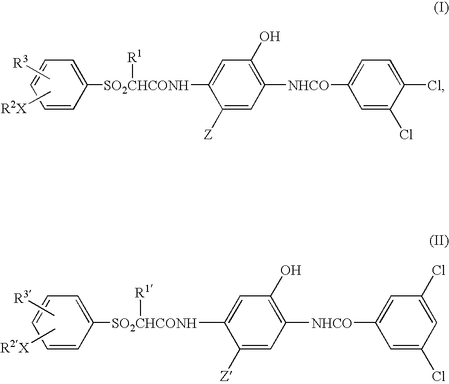
wherein
R¹, R^{1′} represent, independently of one another, a hydrogen atom or an alkyl group,
R², R^{2′} represent, independently of one another, an alkyl or an aryl group,
R³, R^{3′} represent, independently of one another an alkyl, alkenyl, alkoxy, aryloxy, acyloxy, acylamino, sulphonyloxy, sulphamoylamino, sulphonamido, ureido, hydroxycarbonyl, hydroxycarbonylamino, carbamoyl, alkylthio, arylthio, alkylamino or arylamino group or a hydrogen atom,
Z, Z′ represent, independently of one another, a hydrogen atom or a group that may be cleaved under the conditions of chromogenic development,
X, X′ represent, independently of one another, S, NH or NR⁴, and
R⁴ represents an alkyl or an aryl group,
and wherein at least 20% by weight of each of the cyan couplers of formulae (I) and (II), based on the total quantity of cyan couplers, are contained in the red-sensitive layer.

The use of more than one cyan coupler, which differ with regard to the substituents R¹, R² or R³, on the other hand, does not produce a satisfactory result.

In the terms of the present invention, alkyl, alkylene, aralkyl, alkenyl and alkyne groups may be straight-chained, branched or cyclic.

Alkyl, alkenyl, alkyne, alkylene, aryl and heteroaryl groups may, for example, be substituted by alkyl, alkenyl, alkyne, alkylene, aryl, heterocyclyl, hydroxy, carboxy, halogen, alkoxy, aryloxy, heterocyclyloxy, alkylthio, arylthio, heterocyclylthio, alkylseleno, arylseleno, heterocyclyloseleno, acyl, acyloxy, acylamino, cyano, nitro, amino, thione or mercapto groups,

wherein heterocyclyl represents a saturated, unsaturated or aromatic heterocycle, and acyl represents the radical of an aliphatic, olefinic or aromatic carboxylic, carbamic, carbonic, sulphonic, amidosulphonic, phosphoric, phosphonic, phosphorous, phosphinic or sulphinic acid.

In a preferred embodiment of the present invention, R¹ and R^{1′} represent an alkyl group, and in particular an unsubstituted ethyl group; R² and R^{2′} represent an alkyl group, in particular an unsubstituted alkyl group, which preferably contains 4 to 26 carbon atoms, in particular 8 to 20 carbon atoms, and is advantageously straight-chained; R³ and R^{3′} represent a hydrogen atom; and X, X′ represent a sulphur atom. In the present invention, the leaving group Z, Z′ is preferably a chlorine atom.

In the present invention, the total quantity of cyan couplers in the red-sensitive silver halide emulsion layer is preferably between 0.05 g and 2 g, in particular between 0.1 g and 1 g, and particularly preferably between 0.15 g and 0.5 g of coupler per m² of photographic material.

It has also been found that the other advantages of the present invention, apart from the coupler structure, are highly dependent on the proportion of the couplers (I) and (II), based on the total quantity of couplers and the mixing ratio of the couplers (I) and (II). It is therefore preferred if the cyan couplers of formulae (I) and (II) together form at least 50% by weight, in particular at least 75% by weight, and particularly preferably at least 90% by weight, based on the total quantity of cyan couplers contained in the red-sensitive layer. The best results are obtained if only cyan couplers of formulae (I) and (II) are contained in the red-sensitive layer.

The cyan couplers of formulae (I) and (II) may be used in any blends, provided that they each form at least 20% by weight of the total quantity of cyan couplers in the red-sensitive layer. It is, however, preferred to use a larger quantity of the cyan coupler of formula (I) than of the cyan coupler of formula (II). Therefore, in a preferred embodiment of the present invention, at least 50% by weight, in particular 50 to 70% by weight, and particularly preferably 55 to 65% by weight, of cyan couplers (I), based on the total quantity of cyan couplers of formulae (I) and (II) in the red-sensitive layer, are contained in the red-sensitive layer.

In order to select suitable couplers and, in particular, to optimise the mixing ratio thereof, a process has been discovered in which the crystallisation tendency is determined in the coupler emulsion. For this purpose, a solution comprising one part by weight of cyan coupler or cyan coupler mixture, one part by weight of tricresyl phosphate oil former, three parts by weight of ethyl acetate solvent, and 0.3 parts by weight of ethanol solvent was prepared. The low boiling solvents were subsequently distilled off, cooled to room temperature, and the time that it took for crystals to appear was then recorded. Coupler mixtures that take a particularly long time to form crystals have proven to be particularly suitable for the present invention. Test results are listed in the examples. Although it has not been checked, it is assumed that crystallisation also occurs in the copying material, resulting in the rough surface and the low colour output.

The coupler blend according to the invention may readily be preselected using the aforementioned test; however, in order to provide reliable results, a complete copying material must be produced.

Compounds of formulae (I) and (II) that are particularly suitable for the invention are shown below. 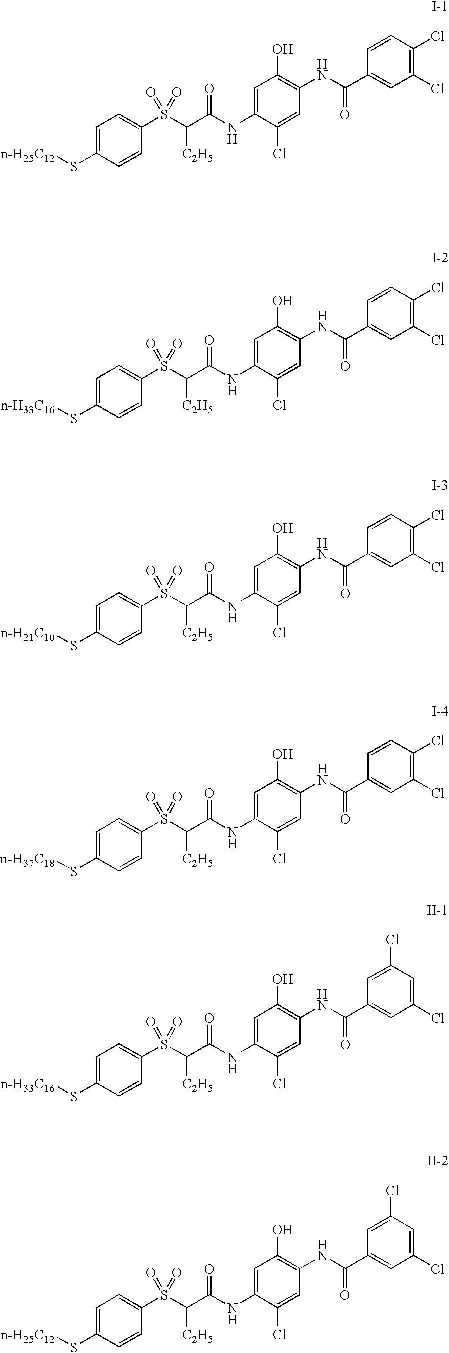 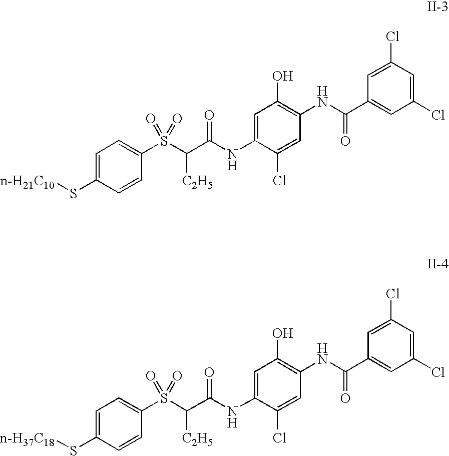
Synthesis of the Coupler I-1

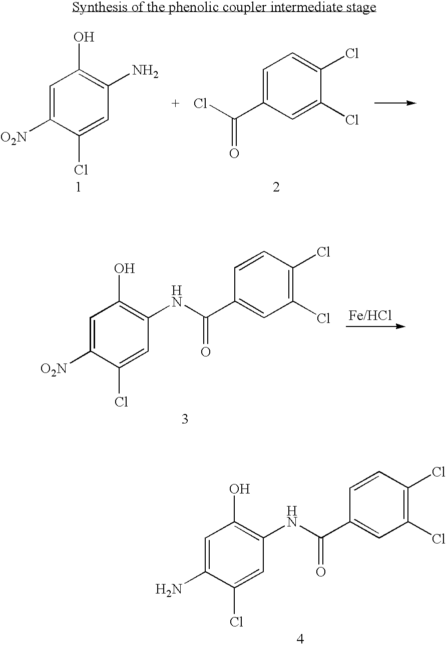

A solution of 185 g (0.87 mol) 3,4-dichlorobenzoylchloride 2 in 50 ml N-methylpyrrolidone was added dropwise to 165 g (0.87 mol) 2-amino-4-chloro-5-nitrophenol 1 in 500 ml N-methylpyrrolidone, while stirring. The mixture was left at room temperature for 1 hour, then stirred again for 2 hours at 60 to 65° C. After cooling, 500 ml of water were slowly added, then suction filtered. Water, then methanol, were stirred in twice, then suction filtered.

Yield: 310 g (98%) 3,

A mixture comprising 310 g (0.86 mol) 3, 171 g of iron powder, 2.2 l ethanol and 700 ml N-methylpyrrolidone was heated to 65° C., while stirring. The heating bath was removed, and 750 ml of concentrated hydrochloric acid were added dropwise within 2 hours. The mixture was then heated under reflux for 1 hour. After cooling, 1 l of water was added dropwise and suction filtered, and the mixture was rinsed with 2 N hydrochloric acid, then with water, until the effluent water was colourless. 1.5 l of water were then stirred into the residue, which was neutralised by adding sodium acetate, before suction filtering. 1.5 l methanol was stirred in twice, then suction filtered.

Yield: 270 g (95%) 4

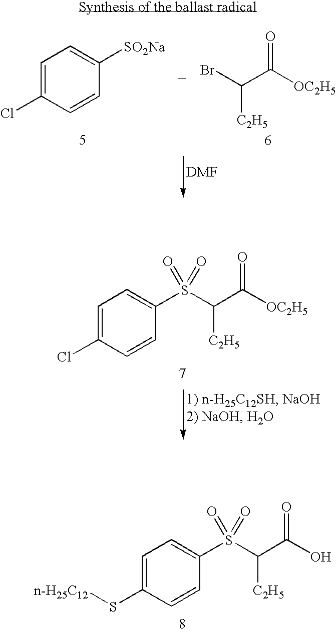

195.0 g (1 mol) 2-bromobutyric acid ethyl ester 6 were placed in 500 ml N,N-dimethylformamide at 50° C. 198.5 g (1 mol) 4-chlorobenzene sulphinic acid sodium salt 5 were added to this solution in portions within 30 minutes. The reaction was exothermic, and the reaction temperature was maintained at 55 to 60° C. The suspension, which is readily stirrable, was then stirred for 1 hour at 50 to 55° C. 7 was not isolated as an intermediate. The mixture was cooled to 20° C., and 40.0 g sodium hydroxide beads (20 to 30 mesh) were added. The reaction was slightly exothermic. Stirring was then continued for 20 minutes at 20 to 25° C., and 202.0 g dodecyl mercaptan were added dropwise within 10 minutes. After approximately 30 minutes, the reaction temperature rose, and it was maintained at 30 to 35° C. by cooling with ice/water. Stirring then continued for 10 hours at room temperature. The reaction mixture was diluted with 1000 ml ethanol, and 88 g 45% sodium hydroxide solution were added for the purpose of saponification. The reaction mixture was heated to 50° C., and a suspension was produced. It was then cooled to room temperature, and the product crystallised. Stirring was continued for four hours at 15° C., the mixture was filtered and the white crystals rinsed in portions with 700 ml ethanol. The damp sodium salt was dissolved in 1500 ml of water at 50° C. 99.0 g of concentrated hydrochloric acid were then added dropwise. The free acid precipitated in an oily form. The suspension was cooled to 20° C., and after approx. 1 hour, the product 8 crystallised. Stirring was continued for 3 hours at room temperature, the white product was suction filtered, rinsed with water on the filter, and dried in the vacuum drying cabinet at 45° C.

Yield 8: 334 g (0.78 mol, 78%).

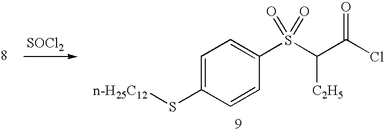

214 g 8 were introduced into 225 ml toluene and 1 ml N,N-dibutylformamide. The reaction mixture was heated to 50 to 55° C., producing a bright yellow solution.

At this temperature, 110 ml thionyl chloride were added dropwise within 1 hour. The reaction was initially exothermic. Stirring then continued for 6.5 hours at 50 to 55° C. After the reaction had finished, the mixture was concentrated at approx. 20 mbar and a bath temperature of 55 to 60° C. The acid chloride was a beige-coloured oil, which slowly crystallised at room temperature.

Yield 9: 224 g, quantitative.

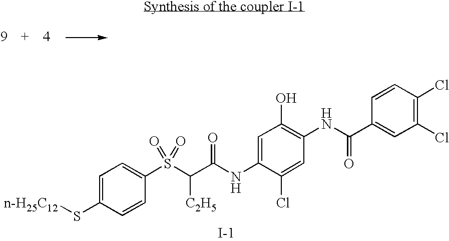

100 g of crude product 2 (approx. 0.2 mol) in 100 ml N-methylpyrrolidone were added dropwise to 66 g (0.2 mol) 4 in 200 ml N-methylpyrrolidone at 5 to 10° C. The mixture was first stirred for 2 hours at room temperature, then for 2 hours at 60° C. The reaction mixture was filtered hot, the filtrate was mixed with 500 ml acetonitrile, cooled to 0° C., suction filtered and rinsed with 50 ml acetonitrile. The product was mixed with 500 ml ethanol and 111 of water, stirred, suction filtered, then rinsed with 300 ml of water and dried.

Yield: 120 g (81%) I-1

Using the known methods, the cyan couplers of the present invention may be introduced into the red-sensitive layer or a layer adjacent thereto. They are conventionally introduced into the red-sensitive layer as emulsates, which are small droplets of coupler, dissolved in a high boiling solvent (oil-former), which may contain further substances, such as dye stabilisers, for example. A possible method for preparing coupler emulsates was described above for the test method.

In a preferred embodiment of the present invention, the cyan couplers of formulae (I) and (II) are used together in one emulsion.

The known methods for preparing coupler emulsions, the known oil-formers and the known additional constituents of emulsions may be used for the present invention. The use of phosphate oil-formers, in particular of trialkyl phosphates and/or of long-chained alcohols comprising at least 8, in particular 10 to 20, and particularly preferably 12 to 14, C-atoms, has proven particularly advantageous.

Although the cyan couplers of the present invention may be combined with the known magenta couplers, in the green-sensitive layer, and the known yellow couplers, in the blue-sensitive layer, colour reproduction surprisingly improves if the magenta coupler in the green-sensitive layer corresponds to formula (III) 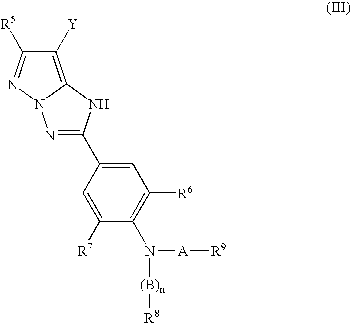
wherein
R⁵ represents a tertiary alkyl radical,
R⁶ and R⁷ each represent a hydrogen atom or a substituent group,
Y represents a hydrogen atom, a halogen atom or an aryloxy radical,
A and B each represent —CO— or —SO₂
n represents 0 or 1,
R⁸ represents a hydrogen atom, an alkyl radical or an aryl radical, and
R⁹ represents an alkyl radical, an aryl radical, an alkoxy radical, an alkylamino radical or an arylamino radical, or
R⁸ and R⁹ may be bound to form a five-, six- or seven-membered ring.

Examples of magenta couplers of formula (III) include:

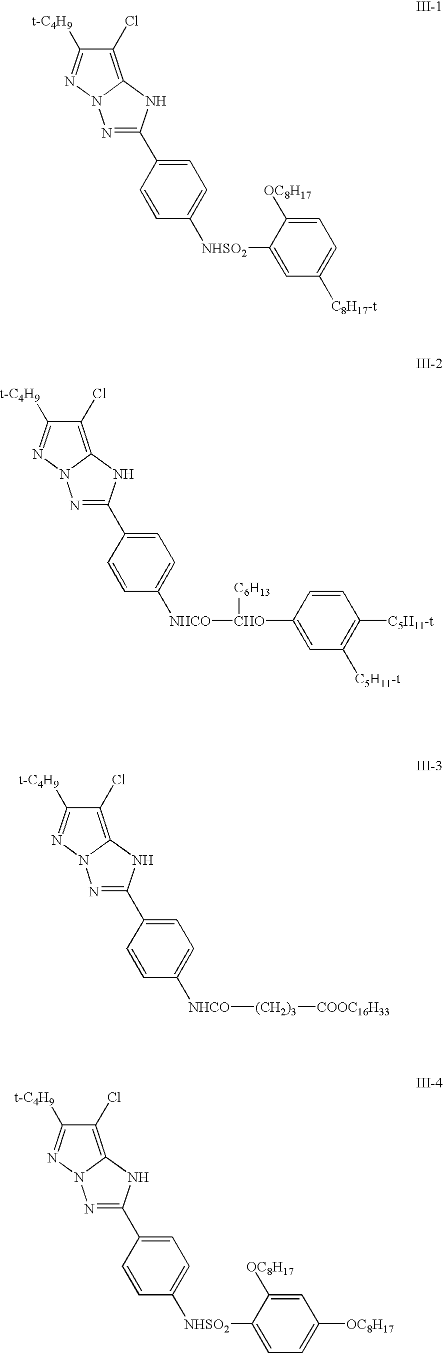

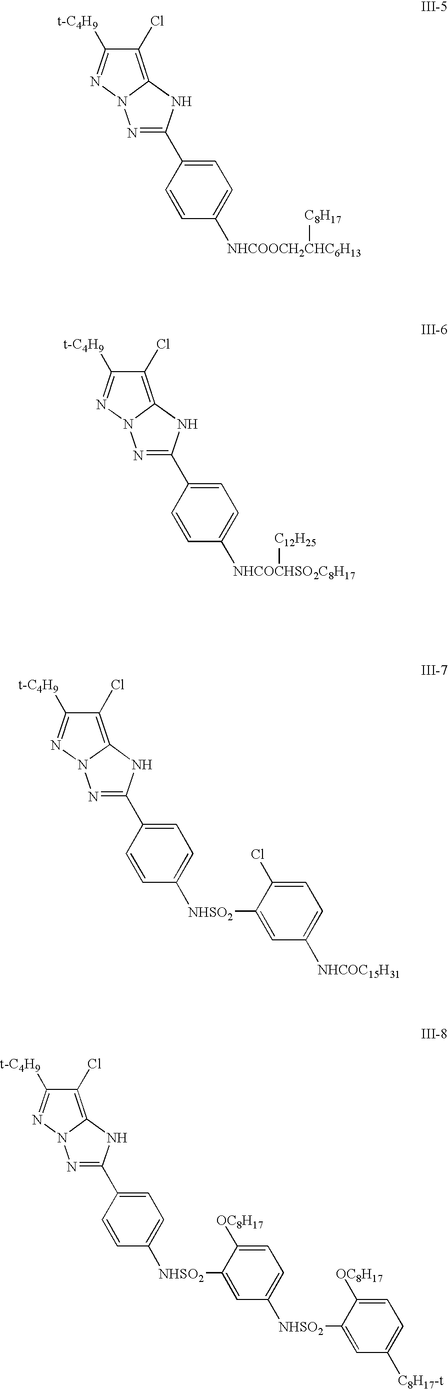

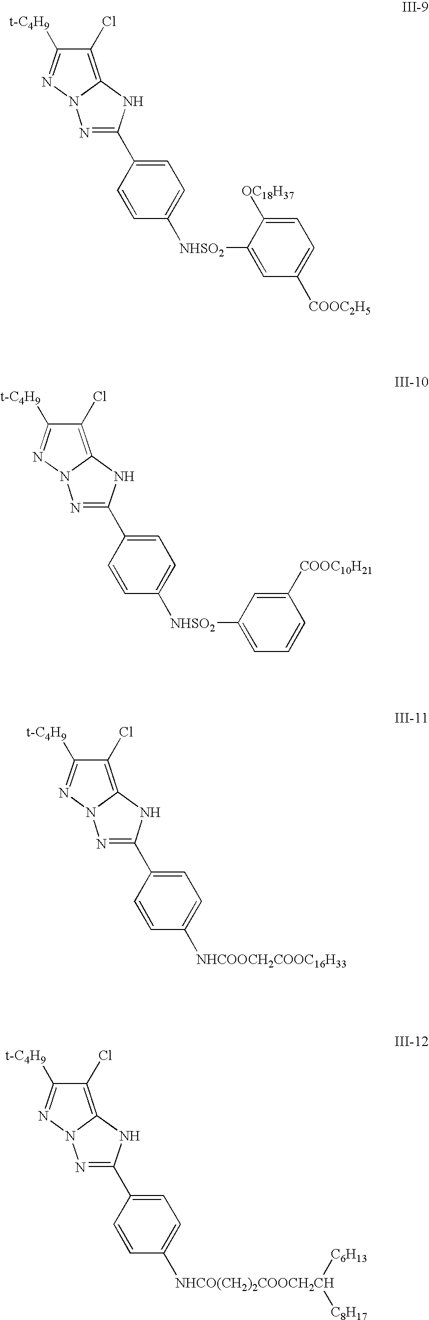

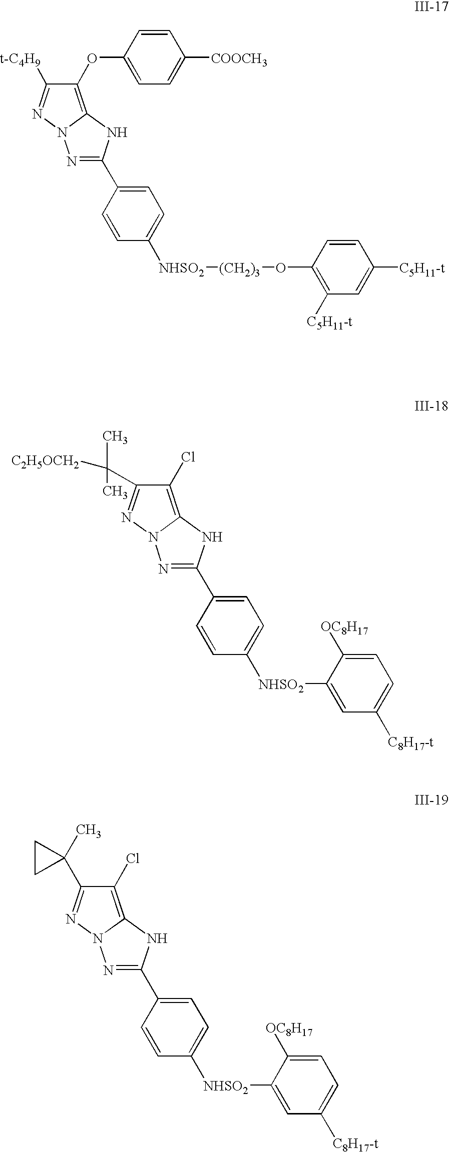

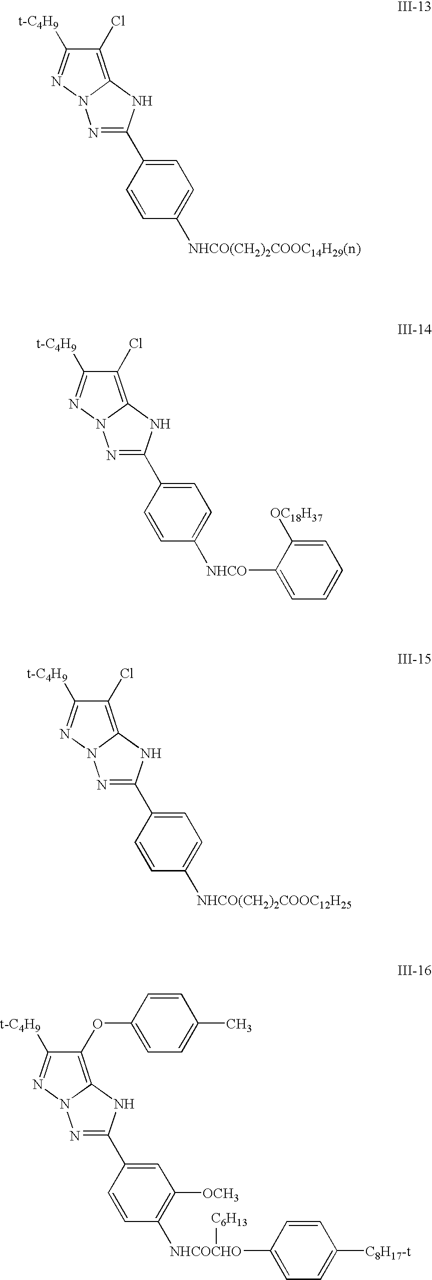

Examples of colour-photographic copying materials include colour-photographic paper, colour reversal photographic paper, cine positive film and semi-transparent display material. Research Disclosure 37038 (1995), Research Disclosure 38957 (1996) and Research Disclosure 40145 (1997) provide an overview.

The photographic copying materials comprise a carrier, to which at least one light-sensitive silver halide emulsion layer is applied. Thin films or foils are particularly suitable as carriers. Research Disclosure 37254, Part 1 (1995), p. 285, and Research Disclosure 38957, Part XV (1996), p. 627, provide an overview of carrier materials and auxiliary layers attached to the fronts and backs thereof.

The colour-photographic copying materials conventionally contain at least one red-sensitive, at least one green-sensitive and at least one blue-sensitive silver halide emulsion layer, and optionally intermediate layers and protective layers.

These layers may be arranged in various ways, depending on the type of photographic copying material. These arrangements will be set out for the most important products:

Colour-photographic paper and colour-photographic display material conventionally comprise on the carrier one blue-sensitive, yellow-coupling silver halide emulsion layer, one green-sensitive, magenta-coupling silver halide emulsion layer, and one red-sensitive, cyan-coupling silver halide emulsion layer (in that order); a yellow filter layer is not required.

The number and arrangement of the light-sensitive layers may be varied in order to obtain specific results. For example, coloured papers may contain intermediate layers that are sensitised differently, via which the gradation is affected.

Binders, silver halide particles and colour couplers are essential components of the photographic emulsion layers.

Research Disclosure 37254, Part 2 (1995), p. 286, and Research Disclosure 38957, Part II.A (1996), p. 598, provide information regarding suitable binders.

Research Disclosure 37254, Part 3 (1995), p. 286, Research Disclosure 37038, Part XV (1995), p. 89, and Research Disclosure 38957, Part V.A (1996), p. 603, provide information regarding suitable silver halide emulsions, the preparation, maturation, stabilisation and spectral sensitisation thereof, including suitable spectral sensitisers.

Pentamethine cyanine with naphthothiazole, naphthoxazole or benzthiazole as the basic terminal groups, which may be substituted with halogen, methyl or methoxy groups and may be 9,11-alkylene-bridged, in particular 9,11-neopentylene-bridged, may also be used as red-sensitisers for the red-sensitive layer. The N,N′-substituents may be C₄-C₈-alkyl groups. The methine chained may also carry substituents. Pentamethines with only one methyl group on the cyclohexene ring may also be used. The red sensitiser may be supersensitised and stabilised by adding heterocyclic mercapto compounds.

The red-sensitive layer may also be spectrally sensitised between 390 and 590 nm, preferably to 500 nm, in order to produce improved differentiation of the red tones.

The spectral sensitisers may be added to the photographic emulsion in dissolved form or as a dispersion. Both the solution and the dispersate may contain additives, such as wetting agents or buffers.

The spectral sensitiser or a combination of spectral sensitisers may be added before, during or after the preparation of the emulsion.

Photographic copying materials contain either silver chloride bromide emulsions with up to 80 mol % AgBr or silver chloride bromide emulsions with over 95 mol % AgCl.

In addition to the cyan and magenta couplers according to the invention, the materials also contain yellow couplers, and optionally additional cyan and magenta couplers mixed with the couplers according to the invention.

Research Disclosure 37254, Part 4 (1995), p. 288, Research Disclosure 37038, Part II (1995), p. 80, and Research Disclosure 38957, Part X.B (1996), p. 616, provide information regarding the colour couplers. For copying materials, the maximum absorption of the dyes formed from the couplers and the colour developer oxidation product is preferably within the following ranges: yellow couplers 440 to 450 nm, magenta couplers 540 to 560 nm, and cyan couplers 625 to 670 nm.

The yellow couplers that are conventionally used in copying materials in association with a blue-sensitive layer are almost entirely two-equivalent couplers of the pivaloylacetanilide and cyclopropylcarbonylacetanilide series.

In a preferred embodiment of the present invention, the yellow couplers belong to the group of the pivaloylacetanilide two-equivalent couplers.

The non-light-sensitive intermediate layers, which are generally arranged between layers having different spectral sensitivities, may contain means that prevent undesirable diffusion of developer oxidation products from one light-sensitive layer into another light-sensitive layer with a different spectral sensitivity.

Suitable compounds (white couplers, scavengers or EOP catchers) may be found in Research Disclosure 37254, Part 7 (1995), p. 292, in Research Disclosure 37038, Part III (1995), p. 84, and in Research Disclosure 38957, Part X.D (1996), p. 621 ff.

The photographic material may also contain UV light-absorbing compounds, optical brighteners, spacers, filter dyes, formalin catchers, light stabilisers, anti-oxidants, Dₘᵢₙ-dyes, plasticisers (latices), biocides and additives for improving the coupler and dye stability, for reducing colour fog and for reducing yellowing, etc. Suitable compounds may be found in Research Disclosure 37254, Part 8 (1995), p. 292, in Research Disclosure 37038, Parts IV, V, VI, VII, X, XI and XIII (1995), p. 84 ff., and in Research Disclosure 38957, Parts VI, VIII, IX and X (1996), p. 607 and 610 ff.

The layers of colour-photographic materials are conventionally cured, i.e. the binder agent that is used, which is preferably gelatine, is crosslinked by suitable chemical processes.

Suitable curing substances may be found in Research Disclosure 37254, Part 9 (1995), p. 294, in Research Disclosure 37038, Part XII (1995), p. 86, and in Research Disclosure 38957, Part II.B (1996), p. 599.

After imagewise exposure, colour-photographic materials are subjected to various treatments according to their nature. Details regarding the procedures and chemicals required therefor, together with exemplary materials, are published in Research Disclosure 37254, Part 10 (1995), p. 294, in Research Disclosure 37038, Parts XVI to XXIII (1995), p. 95 ff., and in Research Disclosure 38957, Parts XVIII, XIX and XX (1996), p. 630 ff.

### EXAMPLES

### Example 1

A colour-photographic recording material that is suitable for a rapid treatment process was produced by applying the following layers, in the indicated order, to a layer carrier made of paper coated on both sides with polyethylene. The quantities indicated refer, in each case, to 1 m². The corresponding quantities of AgNO₃ are indicated for the silver halide application.

Layer Composition 101

Layer 1: (Substrate Layer)

0.10 g gelatine
   Layer 2: (Blue-Sensitive Layer)
blue-sensitive silver halide emulsion (99.5 mol % chloride, 0.5 mol % bromide, average particle diameter 0.75 μm) comprising 0.4 g AgNO₃.
1.25 g gelatine
0.50 g yellow coupler GB-1
0.30 g tricresyl phosphate (TCP)
0.10 g stabiliser ST-1
   Layer 3: (Intermediate Layer)
0.10 g gelatine
0.06 g EOP scarenger SC-1
0.06 g EOP scarenger SC-2
0.12 g TCP
   Layer 4: (Green-Sensitive Layer)
green-sensitive silver halide emulsion (99.5 mol % chloride, 0.5 mol % bromide, average particle diameter 0.45 lm) comprising 0.2 g AgNO₃.
1.10 g gelatine
0.12 g magenta coupler (III-13)
0.40 g TCP
   Layer 5: (UV-Protective Layer)
1.05 g gelatine
0.35 g UV-absorber UV-1
0.10 g UV-absorber UV-2
0.05 g UV-absorber UV-3
0.06 g EOP scarenger SC-1
0.06 g EOP scarenger SC-2
0.25 g TCP
   Layer 6: (Red-Sensitive Layer)
red-sensitive silver halide emulsion (99.5 mol % chloride, 0.5 mol % bromide, average particle diameter 0.48 μm) comprising 0.28 g AgNO₃.
1.00 g gelatine
0.26 g cyan coupler II-1
0.4 g OF-1
   Layer 7: (UV-Protective Layer)
1.05 g gelatine
0.35 g UV-absorber UV-1
0.10 g UV-absorber UV-2
0.05 g UV-absorber UV-3
0.15 g TCP
   Layer 8: (Protective Layer)
0.90 g gelatine
0.05 g optical brightener W-1
0.07 g polyvinylpyrrolidone
1.20 ml silicone oil
2.50 mg spacer made of polymethylmethacrylate, average particle size 0.8 μm
0.30 g instant hardening agent H-1

The further layer compositions differ from 101, in terms of the cyan couplers and the quantities thereof, as shown in Table 1; C are comparative examples; I are examples according to the invention.

Treatment

Samples of the material were exposed by means of a red filter, behind a grey wedge, and processed as follows.

| | | |
|---|---|---|
| a) | Colour developer - 45 s - 35° C. | |
| | Triethanolamine | 9.0 g |
| | N,N-diethylhydroxylamine | 4.0 g |
| | Diethylene glycol | 0.05 g |
| | 3-methyl-4-amino-N-ethyl-N-methane- | 5.0 g |
| | sulphonamidoethyl-aniline-sulphate | |
| | Potassium sulphite | 0.2 g |
| | Triethylene glycol | 0.05 g |
| | Potassium carbonate | 22 g |
| | Potassium hydroxide | 0.4 g |
| | Ethylenediamine tetraacetic acid-di-Na-salt | 2.2 g |
| | Potassium chloride | 2.5 g |
| | 1,2-dihydroxybenzene-3,4,6-trisulphonic acid- | 0.3 g |
| | trisodium salt | |
| | Fill up with water to 1000 ml; pH 10.0 | |
| b) | Bleach-fixing bath - 45 s - 35° C. | |
| | Ammonium thiosulphate | 75 g |
| | Sodium hydrogen sulphite | 13.5 g |
| | Ammonium acetate | 2.0 g |
| | Ethylenediamine tetraacetic acid | 57 g |
| | (Iron-ammonium-salt) | |
| | 25% ammonia | 9.5 g |
| | Fill up with vinegar to 1000 ml; pH 5.5 | |
| c) | Rinsing with water - 2 min - 33° C. | |
| d) | Drying | |

The cyan density and the roughness of the layer surface were then determined. The roughness was assessed qualitatively, as being rough or smooth, by touching. The results are shown in Table 1.

The following compounds were used in Example 1:

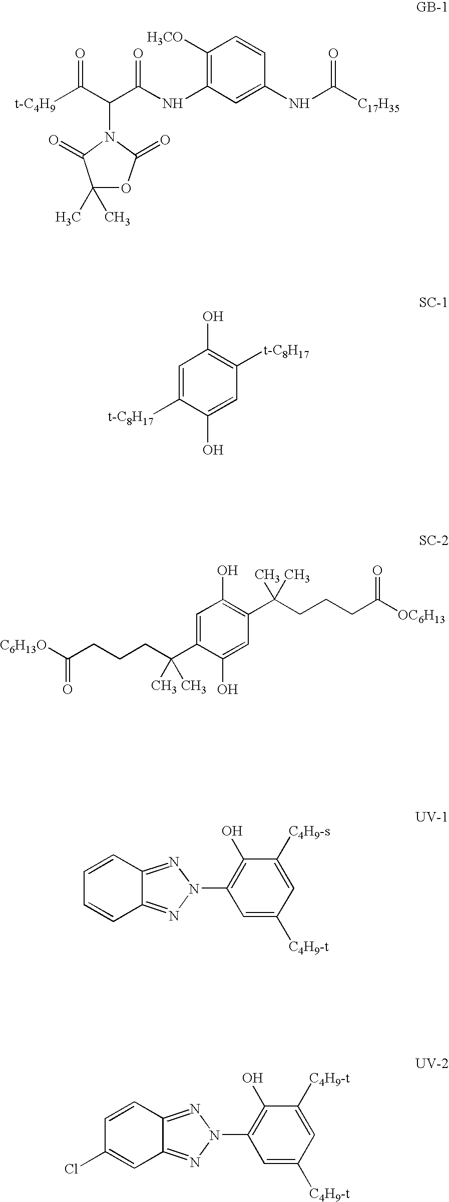

TCP Tricresyl Phosphate

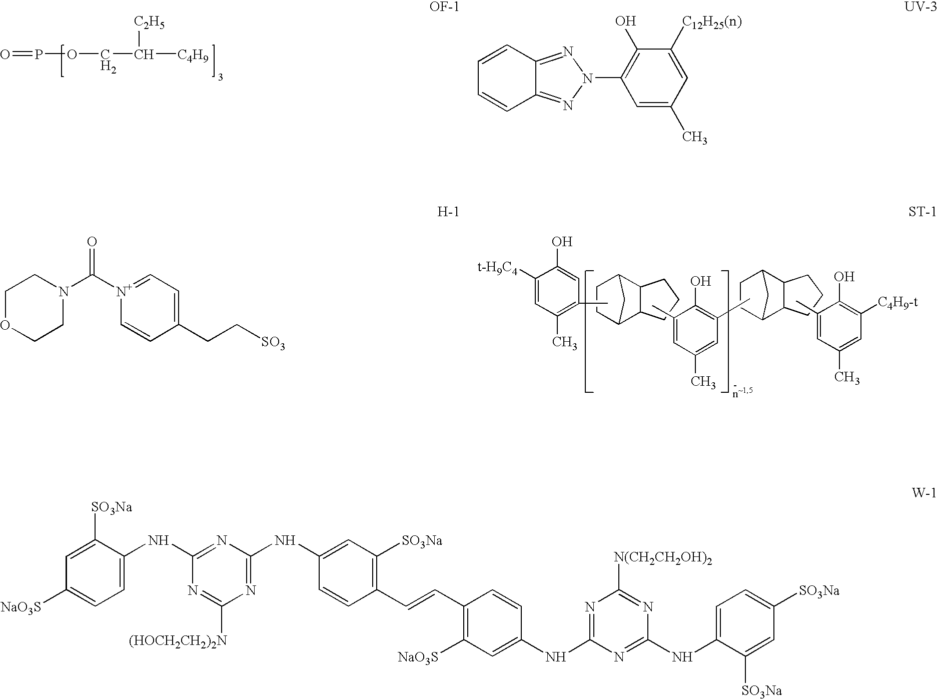

TABLE 1

| | | | | | | Layer |
|---|---|---|---|---|---|---|
| Layer | Layer 6 | % | Layer 6 | % | Cyan color | surface |
| composition | cyan coupler 1 | by weight | cyan coupler 2 | by weight | density | roughness |
| 101(C) | I-1 | 100 | — | — | 0.4 | rough |
| 102(C) | II-1 | 100 | — | — | 0.45 | rough |
| 103(C) | I-1 | 50 | I-2 | 50 | 0.4 | rough |
| 104(C) | II-1 | 40 | II-2 | 60 | 0.38 | rough |
| 105(I) | I-1 | 60 | I-2 | 40 | 2.05 | smooth |
| 106(I) | I-2 | 50 | II-3 | 50 | 1.9 | smooth |
| 107(I) | I-4 | 60 | II-4 | 40 | 1.94 | smooth |
| 108(I) | I-2 | 55 | II-4 | 45 | 1.85 | smooth |
| 109(I) | I-2 | 65 | II-1 | 35 | 1.8 | smooth |

It may be seen from Table 1 that optimal layers with smooth surfaces and adequate colour densities may only be obtained when mixtures according to the invention are used. The advantages are particularly marked if more couplers of formula (I) are used than couplers of formula (II).

### Example 2

Solutions comprising a parts by weight (pts./wt.) cyan coupler A and b pts./wt. cyan coupler B, as shown in Table 2, as well as 1 pt./wt. tricresyl phosphate, 3 pts./wt. ethyl acetate and 0.3 pts./wt. ethanol were prepared. The low boiling solvents were then distilled, cooled to room temperature, and the time that it took until crystals appeared was recorded. The results are reproduced in Table 2.

TABLE 2

| | Cyan | | Cyan | | Time |
|---|---|---|---|---|---|
| Sample | coupler A | Pts./wt. | coupler B | Pts/wt. | (min)* |
| 1 | I-1 | 1 | — | — | <0.5 |
| 2 | II-1 | 1 | — | — | <0.5 |
| 3 | I-2 | 1 | — | — | <0.5 |
| 4 | II-4 | 1 | — | — | <0.5 |
| 5 | I-1 | 0.6 | II-2 | 0.4 | >30 |
| 6 | I-2 | 0.5 | I-1 | 0.5 | 1.5 |
| 7 | I-4 | 0.35 | II-4 | 0.65 | >30 |
| 8 | II-1 | 0.4 | II-2 | 0.6 | <0.5 |
| 9 | I-1 | 0.3 | I-2 | 0.7 | <0.5 |
| 10 | I-1 | 0.65 | II-3 | 0.35 | 25 |
| 11 | I-2 | 0.5 | II-4 | 0.5 | >30 |
| 12 | II-1 | 0.55 | I-2 | 0.45 | >30 |

*Time that it took until crystals appeared.

It is apparent from the above that the pure couplers display a high crystallisation tendency. The crystallisation tendency is only slightly reduced by mixing couplers with the same substitution pattern in the phenyl ring of the benzoyl group, but a different 5-alkyl radical.

The crystallisation tendency is significantly reduced by the mixing according to the invention of couplers with a different substitution pattern in the phenyl ring of the benzoyl group. Copying materials having a high cyan colour density and a smooth surface are obtained with the mixtures having a low crystallisation tendency.

1. Colour-photographic copying material comprising at least one red-sensitive silver halide emulsion layer containing at least two cyan couplers, at least one green-sensitive silver halide emulsion layer containing at least one magenta coupler, and at least one blue-sensitive silver halide emulsion layer containing at least one yellow coupler, characterised in that at least one cyan coupler corresponds to formula (I) and at least one cyan coupler corresponds to formula (II) 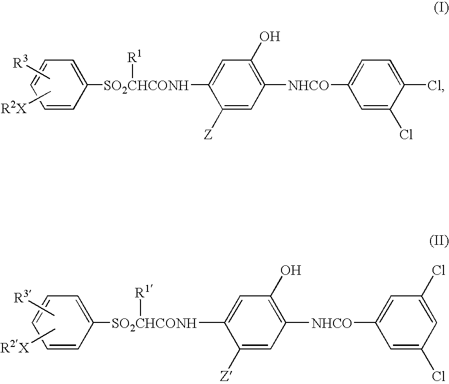
wherein
R¹, R^{1′} represent, independently of one another, a hydrogen atom or an alkyl group,
R², R^{2′} represent, independently of one another, an alkyl or an aryl group,
R³, R^{3′} represent, independently of one another an alkyl, alkenyl, alkoxy, aryloxy, acyloxy, acylamino, sulphonyloxy, sulphamoylamino, sulphonamido, ureido, hydroxycarbonyl, hydroxycarbonylamino, carbamoyl, alkylthio, arylthio, alkylamino or arylamino group or a hydrogen atom,
Z, Z′ represent, independently of one another, a hydrogen atom or a group that may be cleaved under the conditions of chromogenic development,
X, X′ represent, independently of one another, S, NH or NR⁴, and
R⁴ represents an alkyl or an aryl group,
and wherein at least 20% by weight of each of the cyan couplers of formulae (I) and (II), based on the total quantity of cyan coupler, are contained in the red-sensitive layer.

2. Colour-photographic copying material according to claim 1, characterised in that
R¹, R^{1′} represent an alkyl group,
R², R^{2′} represent an alkyl group,
R³, R^{3′} represent a hydrogen atom, and
X, X′ represent a sulphur atom.

3. Colour-photographic copying material according to claim 1, characterised in that Z and Z′ represent a chlorine atom.

4. Colour-photographic copying material according to claim 1, characterised in that R², R^{2′} are unsubstituted alkyl groups.

5. Colour-photographic copying material according to claim 1, characterised in that R², R^{2′} are straight-chained alkyl groups.

6. Colour-photographic copying material according to claim 1, characterised in that R², R^{2′} are alkyl groups that each contain from 4 to 26 carbon atoms.

7. Colour-photographic copying material according to claim 6, characterised in that R², R^{2′} are alkyl groups that each contain from 8 to 20 carbon atoms.

8. Colour-photographic copying material according to claim 1, characterised in that the magenta coupler corresponds to formula (III) 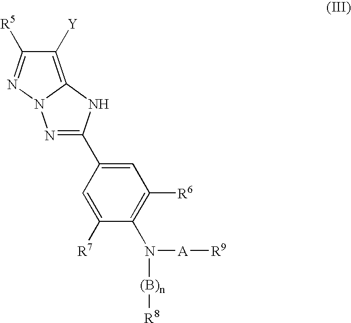
wherein
R⁵ represents a tertiary alkyl radical,
R⁶ and R⁷ each represent a hydrogen atom or a substituent group,
Y represents a hydrogen atom, a halogen atom or an aryloxy radical,
A and B each represent —CO— or —SO₂—
n represents 0 or 1,
R⁸ represents a hydrogen atom, an alkyl radical or an aryl radical, and
R⁹ represents an alkyl radical, an aryl radical, an alkoxy radical, an alkylamino radical or an arylamino radical, or
R⁸ and R⁹ may be bound to form a five-, six- or seven-membered ring.

9. Colour-photographic copying material according to claim 1, characterised in that at least 95 mol % of the silver halides of the silver halide emulsion layers are composed of AgCl.

10. Colour-photographic copying material according to claim 1, characterised in that the yellow couplers belong to the group of the pivaloylacetanilide two-equivalent couplers.

11. Colour-photographic copying material according to claim 1, characterised in that at least 50% by weight of cyan couplers of formula (I), based on the total quantity of cyan couplers of formulae (I) and (II) in the red-sensitive layer, are contained in the red-sensitive layer.

12. Colour-photographic copying material according to claim 1, characterised in that 55 to 65% by weight of cyan couplers (I), based on the total quantity of cyan couplers of formulae (I) and (II) in the red-sensitive layer, are contained in the red-sensitive layer.

13. Colour-photographic copying material according to claim 3, characterised in that R², R^{2′} are alkyl groups that each contain from 8 to 20 carbon atoms.

14. Colour-photographic copying material according to claim 13, characterised in that
R¹, R¹′ represent an alkyl group,
R³, R^{3′} represent a hydrogen atom, and
X, X′ represent a sulphur atom.
